(19) United States
(12) Patent Application Publication
(10) Pub. No.: US 2003/0143983 A1
(43) Pub. Date: Jul. 31, 2003

(54) Email alert device and method

(76) Inventor: Les Crampton, Queensland (AU)

Correspondence Address: John F Hoffman, Baker & Daniels, Suite 800, 111 East Wayne Street, Fort Wayne, IN, 46802, US

(21) Appl. No.: 10/221,929

(22) PCT Filed: Mar. 16, 2001
(86) PCT No.: PCT/AU01/00294

(51) Int. Cl. H04M 3/42

(52) U.S. Cl. 455/414; 455/412

(57) ABSTRACT

A system and method of providing a user with an alert, such as a visual or audible alert that one or more email messages have been received at a designated email account. The system and method operates by intermittently querying the status of the account at the server where the account is held over an on-line network. Upon receiving a positive indication that email has been received, an alert message is sent to a pre-determined location via the telephone network. The alert may be sent to a visual display of a dedicated email alert device, or may be sent to an existing phone such that a short ring acts as the alert.

### FIELD OF THE INVENTION

The present invention relates generally to electronic devices, systems and methods for use in telecommunications to provide an indication of an event that is occurring or has occurred. More particularly, the present invention relates to a device, system or method for use with internet communication equipment and systems to provide an indication that there has been a transmission. Even more particularly, the present invention relates to a device and method for providing an indication, preferably a visual display or audible alert, that a transmission or similar has been received at a particular e-mail address.

### BACKGROUND OF THE INVENTION

The use of electronic communications is expanding such that an increasingly large number of communications are being received and sent using the facilities provided by telecommunications systems, such as on-line networks including the Internet. At present, users of Internet services subscribe to an Internet Service Provider (ISP) or an account provider in order to, inter alia, forward and receive communications, including email via the Internet. In order to determine whether an e-mail message has been received at a subscriber's e-mail address it is necessary for the subscriber to turn on the computer, log on to the ISP or account provider and determine whether any e-mail messages have been received in the subscriber's account by the subscriber's computer interrogating the ISP or account provider.

Logging on to the ISP and/or a particular account provider, either continually or periodically, is time-consuming, expensive and very inefficient if the only reason for switching the computer on and logging on to the ISP and/or account provider is on the offchance of finding whether or not there are any e-mail messages.

Additionally, when expecting an e-mail message or e-mail attachment which a user wishes to receive as soon as possible, it is necessary to remain constantly logged on to the ISP and/or account provider for a period of time or to repeatedly check whether new email messages or attachments have been received. The process of repeatedly checking with the ISP is particularly time-consuming and expensive since each new enquiry requires a separate phone call, which is charged by the telecommunication service provider. Further, if the subscriber remains connected to the ISP or a particular account provider for any length of time, the overall cost of remaining connected can be relatively expensive. This is because the time of the connection charged by the telecommunications supplier as well as the actual time connected to the ISP or account provider is in some circumstances added to the total cost of the subscription paid by the subscriber.

Therefore, there is a need to provide users with an indication that e-mail has been received without users having to unnecessarily turn on their computer and log onto their ISP or account provided or continually remain logged onto their ISP or account provider.

It is therefore an object of this invention to provide a means and method of advising users that there is an e-mail message or e-mail attachments waiting to be read without requiring users to go to the effort and expense of turning on their computer or logging onto a network. It is another object of the invention to provide such a means and method of advising users without incurring network charges for providing the advice.

Any discussion of documents, devices, acts or knowledge in this specification is included to explain the context of the invention, it should not be taken as an admission that any of the material formed part of the prior art base or the common general knowledge in the relevant art on or before the priority date of the claims herein.

### SUMMARY OF THE INVENTION

According to one aspect, the present invention provides, a system for a service provider to provide a user with an indication of unread electronic messages stored in at least one electronic account connected to a data communications network, the system including:

a database for storing the address of the users at least one electronic account and at least one corresponding contact number;

a searching means to search the database to locate the address of the users at least one electronic account and conduct a search to determine the location of the users at least one electronic account;

a query moans to query the status of the at least one account to determine the presence of unread electronic messages; and

an alerting means operable to transmit a pre-determined signal to the at least one corresponding contact number in the event that the users account includes unread messages,

wherein the transmitted pre-determined signal causes an indication to the user of unread electronic messages said indication occurring without the service provider incurring communication charges for causing transmission of the pre-determined signal and where the predetermined signal is transmitted repeatedly to the corresponding contact number.

According to another aspect, the present invention provides in a data communications network having one or more users with accounts at one or more addresses, a method of a service provider providing an alert to a user to indicate the user's account contains unread messages, the method including the steps of:

the service provider ascertaining the user's one or more account addresses;

implementing a search to locate the users one or more accounts;

querying the status of the one or more accounts to ascertain whether the accounts contain any unreadmessages; and

upon determining the presence of one or more unread messages in an account, transmitting an alert signal to one or more pre-defined contact numbers, the alert signal causing an indication recognisable by the user as an indication of the presence of unread messages, the transmission of the alert signal avoiding a communication charge to the service provider wherein the alert signal is transmitted repeatedly to the one or more predefined contact numbers.

In a further aspect, the present invention provides a computer program product including a computer usable medium having computer readable program code and computer readable system code embodied on said medium for communicating an alert signal based upon the status of an account connected to a date communications network, said computer program product further including computer readable code within said computer usable medium for:

ascertaining the account address from a database;

implementing a search to locate the account;

querying the status of the account to ascertain whether the account contains any unreadmessages; and

upon obtaining a positive status indicating one or more unread messages exist in the account, transmitting an alert signal to one or more pre-defined contact numbers such that transmission of the alert signal occurs without incurring communication charges and where the alert signal is transmitted repeatedly to the one or more predefined contact numbers.

In yet a further aspect, the present invention provides an indicating device adapted to communicate with a communications network and operable to receive a pre-determined signal transmitted by a system, said pre-determined signal being transmitted by the system upon determining the presence of unread electronic messages in a users at least one electronic account, wherein the indicating device indicates to a user the presence of unread electronic messages upon receiving the pre-determined signal, the pre-determined signal being received by the indicating device and the indication being provided to the user without incurring communication charges the indicating device receiving repeated transmissions of the predetermined signal until the user accesses their unread electronic messages.

The essence of the invention lies in the ability to monitor accounts and to provide an indication to a user that a message has been received and without the provider of the indication incurring communication connection costs, or call transmission costs in relation to providing the indication without a user incurring the expense or inconvenience of turning on their computer or network interface device or logging onto an ISP or account providers account and unnecessarily incurring ISP or account service provider service costs as well as communication connection costs.

Throughout this specification, reference is made to the receipt electronic messages and it should be recognised that this term includes electronic mail messages and attachments to electronic mail messages as attachments effectively form part of the message. Attachments to electronic mail messages occur in many forms including text documents, scanned images, voice or video files. These types of attachments may be used for various reasons including the sending of documents representing invoices or accounts.

Similarly, references to a contact number should be understood to refer to any type of contact number including a telephone number or any other type of communications network identification number.

### BRIEF DESCRIPTION OF THE DRAWINGS

An embodiment of the present invention relating specifically to electronic mail messages will now be described by way of example with reference to the following drawings in which:

FIG. 1 is a schematic view of one form of a system into which an e-mail alert device according to an embodiment of the present invention may be connected;

FIG. 2 is a schematic view of a further form of a system into which an e-mail alert device according to an embodiment of the present invention may be connected;

FIG. 3 is a schematic view of a still further form of a system into which an e-mail alert device according to an embodiment of the present invention may be connected;

FIG. 4 is a schematic view of a still further form of a system into which an e-mail alert device according to an embodiment of the present invention may be connected; and

FIG. 5 is a flow chart illustrating a method of providing an email alert as a service according to an embodiment of the invention.

### DESCRIPTION OF PREFERRED EMBODIMENT

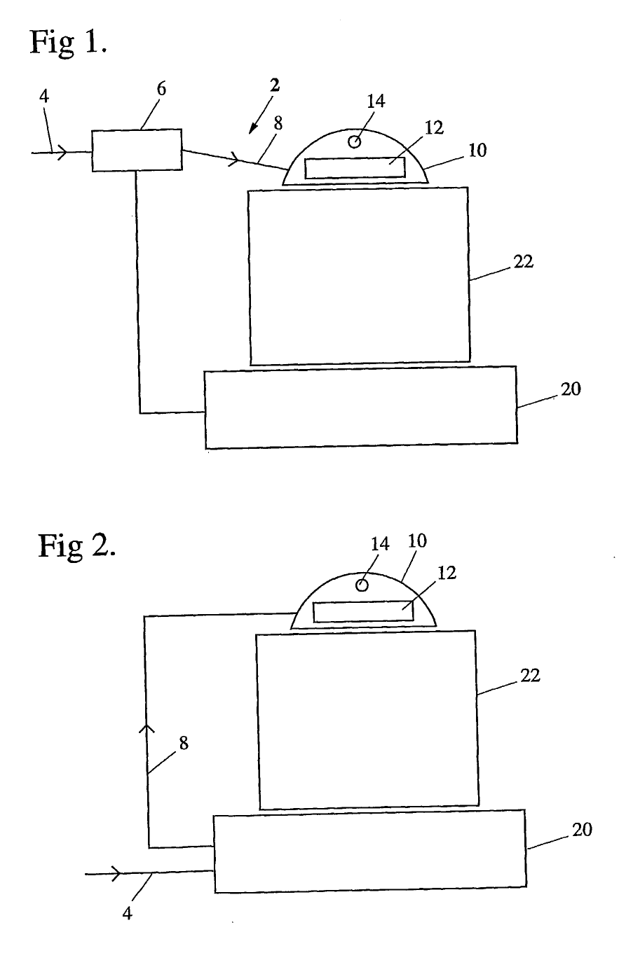

In FIG. 1 there is shown one form of a system generally denoted as (2) in which an e-mail alert device (10) according to one embodiment of the present invention may be connected. In this embodiment a telephone line (4) is permanently connected to modem (6) which is permanently in operation. A further permanent connection such as conductor (8) is provided between modem (6) and e-mail alert device (10), thereby “piggy backing” the alert device to the landline (4). It is to be noted that conductor (8) can be connected directly to phone line (4) or may be internally connected to phone line (4) within modem (6). E-mail alert device (10) is provided with a display screen (12) or similar and a reset button (14). The e-mail alert device is provided with other controls as needed or as necessary. For example, controls for varying the intensity of the light being emitted by the display screen may be provided.

In FIG. 2 an alternative way of connecting the e-mail alert device (10) of the present invention to a personal computer is provided. In this embodiment the phone line (4) is permanently connected to PC (20) such as to the internal modem of the PC. Conductor (8) at one end is connected to the internal modem of the PC and at the other end is connected to the e-mail alert device (10).

In both systems illustrated in FIGS. 1 and 2 the e-mail alert device (10) is provided with a visual display (12) such as for example, in the form of the LED screen. This screen can display an indication of the number of e-mails received or of the number of other events which have occurred and been detected by device (10). The device (10) also includes a memory (not shown) for storing address details of the one or more mailboxes that are to be monitored.

In operation, according to one embodiment of the invention, the email alert device (10), queries the status of one or more mailboxes at one or more relevant ISP addresses. In this regard, a user may have one or more email accounts with multiple service providers. For POP3 (Post Office Protocol 3) email servers, the query is implemented over an on-line network using POP3. Other protocols may also be used as applicable, however most email servers are POP3 servers.

The email alert device will therefore periodically query the status of as many mailboxes as required and when an entry in a mailbox is detected an alert is activated. For the alert device of FIGS. 1 and 2, the device effects the alert by providing relevant information on the visual display (12). Preferably the information on the display includes an indication of the relevant account and the number of emails therein.

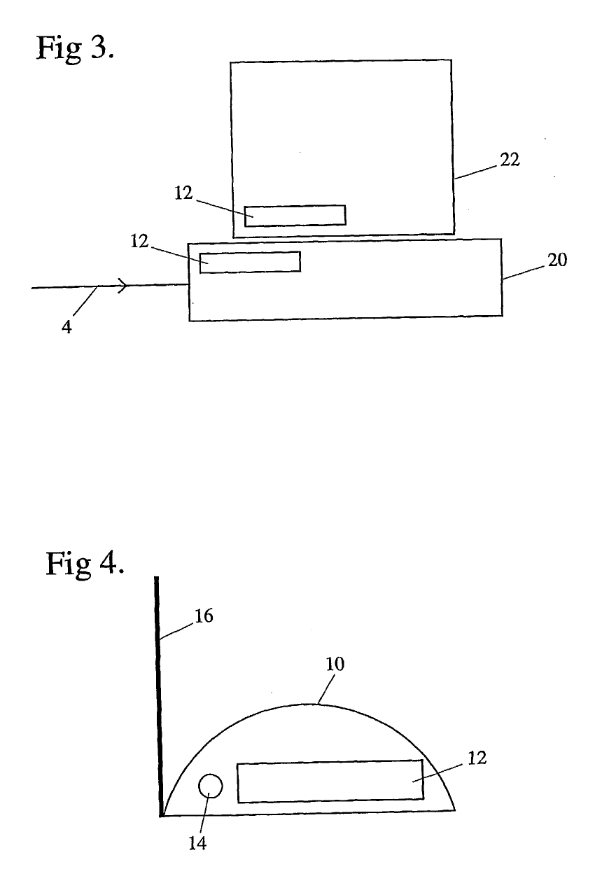

In the arrangement of FIG. 3, phone line (4) is connected to the PC (20) directly. The personal computer (20) or monitor (22) is provided with a display means (12) such that when an e-mail message has been detected in a relevant mailbox with an ISP and detected by the alert device, the e-mail alert device, which is provided within the PC, is activated so as to provide a visual display on either the PC monitor (22) itself or on the display means (12).

In the embodiment of FIG. 4 the email alert device (10) has a suitably arranged antenna (16) with which to detect signals via a wireless connection, such as Bluetooth. The antenna is permanently powered by its own power source, such as batteries, or powered externally by the mains. When the antenna receives a signal responsive to a query at a relevant ISP mailbox via, for example, a modem, the signal is sent via suitable receiving circuitry to the detector of the device (10). Upon the detector detecting a relevant message, a signal is sent to activate the display means.

In this embodiment the email alert device may be a stand-alone device or connected to the PC or may be inbuilt within the PC to provide an activated display means on the PC or monitor.

In another embodiment of the present invention, the email alert system is implemented via software and uses existing equipment at the user's premises, such as an existing telephone, in order to alert the user of received email. In this regard, the user of the services may implement the software themselves, or they may subscribe to a provider of the email alert services.

At any rate, the party implementing the software would install the software on a computing means such as a server, where the server has a connection to the Internet, and/or a connection to the public telephone network and a database containing one or more user's details, such as the address of the user's email mailbox and the phone number to which they require email alerts to be sent

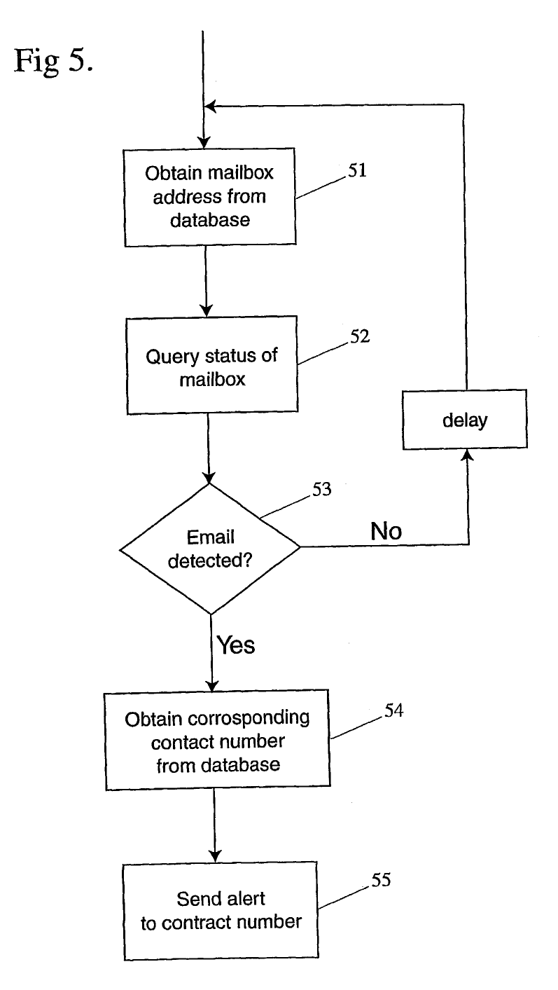

With reference to FIG. 5, the fundamental operation of the server involves periodically cycling through the list of user account addresses contained in the database (51). For each user entry, the POP3 protocol is used to query the status of the mailbox at the particular ISP address (52). This query is performed over the Internet and hence the server need not reside at the premises of the ISP where the email account is located. Also, since the query is undertaken over the Internet, this embodiment of the invention has portability and may be performed by anyone at any location with access to the Internet.

When an email is detected (53) in a particular user's mailbox, a contact number corresponding to the mailbox address at which email was detected, is retrieved from the database (54) and an alert is sent via the telephone network to the user's designated contact number (55). The contact number may be that of a landline phone or a mobile phone or an account number that relates to an indicating device. Preferably the alert is an audible alert that produces a distinctive ring at the user's phone, such as a short ring, with the aim of not incurring any call charges. The distinctive ring tone will be recognised by the user as indicating unread email messages or attachments and they will not answer the incoming call. This enables a services provider that provides the alert to users to avoid incurring a call connection and/or call transmission charge whilst providing the alert. In a particularly preferred embodiment, a user may select the ring tone by programming their phone to provide that tone when receiving a call from the service provider. It is also preferable that the audible alert be sent at periodic intervals (e.g. once every few hours) while there is unread mail at the user's ISP account.

A visual alert may also be provided in conjunction with the audible alert. For example, an optional accessory to the user's landline phone which provides the alert is a visual alert device that detects the short rings and thereafter flashes a light to indicate the presence of email. Alternatively, software in a mobile phone may be utilised to provide a visual alert on the phone's screen.

In this respect, a mobile phone may be programmed to recognise calls received from a particular source and cause the display of a message on the screen of the mobile phone or mobile communication device. It is also possible for the system to call a users mobile phone from a different source depending upon the type of unread email message detected in the users email account.

Therefore, by using this embodiment of the invention, users would be alerted to the presence of email via a designated phone number of an existing phone. This embodiment of the invention is advantageous in that the software is able to be utilised by a service provider, such as the ISP or other telecommunications service provider, in order to offer the service of alerting people to the fact that they have email messages waiting at their ISP account. When used in this way, the customers need not obtain any hardware, as their existing phone may be used to provide the alert.

This email alert service would preferably be effected via a web site set up for the provider of the services. For example, the site could provide a login account for each user of the alert services, and allow those users to stipulate their requirements as necessary. The site could also allow new users to register for the service.

Examples of consumer choice options that could be offered include allowing a user to designate the times at which alerts can be sent to their designated phone, so as to prevent alerts from occurring at inappropriate times, such as during the late hours of the night or weekend mornings.

Other configuration options include a setting for the number of email messages to be received before an alert is triggered. For example, a user could elect to only be alerted if there were three or more email messages waiting. Alternatively, the user may stipulate that an alert only be sent where an email is received from certain addresses or not to send an alert when email is received from certain addresses. Further, the system may be configured so that different alerts are sent depending upon the originating addresses from whom the emails are received. For example, different ring tones could be used depending upon the origination address of the email, and also a visual message may be provided indicating the origination address.

From this description, it is apparent that the present invention, whether implemented via software or as a system, allows a user's computer not be turned on at all times. Instead, the user's computer may be switched off for lengthy periods of time, until such time as an alert indication is received.

Hence, it is only when an alert indication is provided that it is necessary to operate the computer to retrieve the e-mail message. Even if a user has a “broad band” connection to a communication network such that they can be effectively logged on at all times, users will most likely prefer to switch off their computer or network interface devices until they are required (e.g. until email messages arrive in their account). The present invention provides a relatively low-cost and efficient indication of when an e-mail message has been received without the need for a subscriber to keep their computer switched on.

The present invention is not limited in scope to the described embodiment or embodiments but rather the scope of the present invention is broader so as to encompass other methods and forms of the device, other ways of connecting the device into the telecommunication system, such as the Internet, and the use of the various forms of the device in other applications.

It is also to be appreciated that the email content may be of any type such as plain text or containing text, voice, video or image files.

The claims defining the invention are as follows:

1. A system for a service provider to provide a user with an indication of unread electronic messages stored in at least one electronic account connected to a data communications network, the system including:
a database for storing the address of the users at least one electronic account and at least one corresponding contact number;
a searching means to search the database to locate the address of the users at least one electronic account and determine the location of the users at least one electronic account;
a query means to query the status of the at least one account to determine the presence of unread electronic messages; and
an alerting means operable to transmit a pre-determined signal to the at least one corresponding contact number in the event that the users account includes unread messages,
wherein the transmitted pre-determined signal causes an indication to the user of unread electronic messages said indication occurring without the service provider incurring communication charges for causing transmission of the pre-determined signal and where the predetermined signal is transmitted repeatedly to the corresponding contact number.

2. A system according to claim 1 wherein the searching means determines the location of the users at least one electronic account by conducting a search of the date communications network.

3. A system according to either claim 1 or claim 2 wherein the user receives the indication of unread electronic messages the indication being recognisable by the user as indicating the presence of unread messages in at least one of the users electronic accounts.

4. A system according to any one of the preceding claims wherein the user selects the indication that will be provided in the event that a predetermined signal is received.

5. A system according to any one of the preceding claims wherein the pre-determined signal causes an audible indication of the presence of unread messages.

6. A system according to any one of the preceding claims wherein the pre-determined signal causes a visual indication of the presence of unread messages.

7. A system according to any one of the preceding claims wherein the contact number is a telephone number.

8. A system according to claim 7 wherein the telephone number corresponds to a telephone connected to the POTS.

9. A system according to claim 7 wherein the telephone number corresponds to a mobile telephone.

10. A system according to claim 9 wherein the mobile telephone is operable to receive the pre-determined signal and provide a visual indication to the user indicating the presence of unread messages in an account.

11. A system according to any one of the preceding claims wherein the repeated transmission of the predetermined signal occurs in accordance with a first predefined time schedule.

12. A system according to claim 11 wherein the database includes the first predefined time schedule.

13. A system according to either claim 11 or 12 wherein the user may alter the first predefined time schedule.

14. A system according to any one of the preceding claims wherein the pre-determined signal is transmitted for a relatively short duration of less than 5 seconds.

15. A system according to any one of the preceding claims wherein the pre-determined signal provides an indication of the presence of unread messages without transmitting any date.

16. A system according to any one of the preceding claims wherein the repeated transmission of the predetermined signal ceases upon the user accessing the unread electronic messages.

17. A system according to any one of the preceding claims wherein the searching means conducts a search of the database according to a second predefined time schedule.

18. A system according to claim 17 wherein the database includes the second predefined time schedule.

19. In a data communications network having one or more users with accounts at one or more addresses, a method of a service provider providing an alert to a user to indicate the user's account contains unread messages, the method including the steps of:
the service provider ascertaining the user's one or more account addresses;
implementing a search to locate the users one or more accounts;
querying the status of the one or more accounts to ascertain whether the accounts contain any unreadmesages; and
upon determining the presence of one or more unread messages in an account, transmitting an alert signal to one or more pre-defined contact numbers, the alert signal causing an indication recognisable by the user as an indication of the presence of unread messages, the transmission of the alert signal avoiding a communication charge to the service provider wherein the alert signal is transmitted repeatedly to the one or more predefined contact numbers.

20. A method according to claim 19 wherein the search to locate a users one or more accounts includes a search of the data communications network.

21. A method according to either claim 19 or 20 wherein the user receives the indication of one or more unread electronic messages, the indication being recognisable by the user as indicating the presence of unread messages.

22. A method according to claims 19,20 or 21 wherein the account is queried via an on-line network.

23. A method according to any one of claims 19, 20, 21 or 22 wherein the account is queried using POP3.

24. A method according to any one of claims 19 to 23 wherein the alert signal is only sent at designated times or during one or more designated time periods.

25. A method according to any one of claims 19 to 24 wherein the alert signal is sent only when a designated number of messages are received at a particular account.

26. A method according to any one of claims 19 to 25 wherein the alert signal is an audible alert and/or visual alert.

27. A method according to claim 26 where the alert signal includes an audible alert, and the audible alert is a short ring.

28. A method according to any one of claims 19 to 27 further including the step of ascertaining an originating address of each receivedmessage.

29. A method according to claim 28 wherein different alert signals are sent to the one or more predefined contact number dependant upon the originating address of the received message.

30. A method according to any one of claims 19 to 27 wherein the repeated transmission of alert signals cease upon a user accessing their unread electronic messages.

31. A computer program product including a computer usable medium having computer readable program code and computer readable system code embodied on said medium for communicating an alert signal based upon the status of an account connected to a data communications network, said computer program product further including computer readable code within said computer usable medium for:
ascertaining the account address from a database;
implementing a search to locate the account;
querying the status of the account to ascertain whether the account contains any unreadmessages; and
upon obtaining a positive status indicating one or more unread messages exist in the account, transmitting an alert signal to one or more pre-defined contact numbers such that transmission of the alert signal occurs without incurring communication charges and where the alert signal is transmitted repeatedly to the one or more predefined contact numbers.

32. A computer program product according to claim 31 wherein the computer readable code causes the step of the implementation of the search to locate the account to include conducting a search of the data communications network.

33. A computer program product according to either claim 31 or 32 wherein the account is queried via an on-line network.

34. A computer program product according to claim 33 wherein the account is queried using POP3.

35. A computer program product according to any one of claims 31 to 34 wherein the alert is only sent at designated times or during one or more designated time periods.

36. A computer program product according to any one of claims 31 to 35 wherein the alert is sent only when a designated number of messages are received at a particular account.

37. A computer program product according to any one of claims 31 to 36 wherein the alert signal generated is an audible alert and/or visual alert.

38. A system according to claim 7 wherein the telephone number corresponds to a reception device operable to receive said predetermined signal and indicate to a user the presence of unread messages.

39. An indicating device adapted to communicate with a communications network and operable to receive a pre-determined signal transmitted by a system, said pre-determined signal being transmitted by the system upon determining the presence of unread electronic messages in a users at least one electronic account, wherein the indicating device indicates to a user the presence of unread electronic messages upon receiving the predetermined signal, the pre-determined signal being received by the indicating device and the indication being provided to the user without incurring communication charges the indicating device receiving repeated transmissions of the predetermined signal until the user accesses their unread electronic messages.

40. An indicating device according to claim 39 wherein the indication is audible.

41. An indicating device according to claim 39 wherein the indication is visual.

42. An indicating device according to any one of claims 39 to 41 wherein the device is only operable to receive signals.

43. An indicating device according to claim 39 wherein the indicating device is a mobile phone and the user selects the indication by programming the mobile phone to generate a recognisable ring tone when a predetermined signal is received from the system.

44. An indicating device according to claim 39 wherein the indicating device is a mobile phone having a display screen and the user selects the indication by programming the mobile phone to cause a visual display on the mobile phone display screen when a predetermined signal is received from the system.

45. An indicating device according to claim 44 wherein the particular visual display on the mobile phone caused by the reception of a predetermined signal depends upon the source of the predetermined signal.

46. An indicating device according to claim 44 wherein the particular visual display on the mobile phone caused by the reception of a predetermined signal depends upon the predetermined signal received.

47. A system according to any one of claims 1 to 18 wherein the electronic messages are electronic mail messages and the electronic account is an electronic mail account.

48. A method according to any one of claims 19 to 30 wherein the accounts are electronic mail accounts and the messages are electronic mail messages.

49. A computer program product according to any one of claims 31 to 38 wherein the account is an electronic mail account and the messages are electronic mail messages.

50. An indicating device according to any one of claims 39 to 46 wherein the electronic messages are electronic mail messages and the electronic account is an electronic mail account.
